(19) United States
(12) Patent Application Publication
(10) Pub. No.: US 2024/0119182 A1
(43) Pub. Date: Apr. 11, 2024

(54) METHODS AND APPARATUS FOR ENHANCED DATA CORRUPTION DETECTION

(71) Applicant: William E. Lamie, Rancho Santa Fe, CA (US)

(72) Inventor: William E. Lamie, Rancho Santa Fe, CA (US)

(21) Appl. No.: 18/377,719

(22) Filed: Oct. 6, 2023

Related U.S. Application Data
(60) Provisional application No. 63/414,439, filed on Oct. 7, 2022.

(51) Int. Cl. G06F 21/64; G06F 11/08

(52) U.S. Cl. CPC G06F 21/64; G06F 11/08

(57) ABSTRACT

Method and apparatus for providing enhanced detection of data corruption in computer programs (e.g., real-time operating systems (RTOS) and application programs). In one exemplary embodiment, such detection is effected via use of a low-complexity verification code algorithm, which can be implemented in as little as four (4) assembly instructions. This low overhead approach advantageously makes the data corruption detection feasible in real-time and/or resource constrained devices. Additionally, the data corruption detection verification code of the present disclosure can be used as a verification fingerprint for any important data, such as that in RTOS-based applications relating to, e.g., (i) function pointers, (ii) function return addresses, (iii) stack and/or buffer corruption, and (iv) linked-list and general pointer corruption.

### PRIORITY AND RELATED APPLICATIONS

This application claims priority to co-owned and co-pending U.S. Provisional Patent Application Ser. No. 63/414,439, filed on Oct. 7, 2022 of the same title, which is incorporated herein by reference in its entirety.

Additionally, this application is generally related to the subject matter of co-owned and co-pending U.S. Provisional Patent Application Ser. No. 63/414,434 filed on Oct. 7, 2022, and entitled “METHODS AND APPARATUS DATA ENCAPSULATION FOR OPERATING SYSTEMS,” incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### 1. Technological Field

The present disclosure relates generally to the field of computerized operating systems, including in one exemplary aspect Real-Time Operating Systems (RTOS) for, inter alia, deeply embedded and resource-constrained devices. Specifically, in one exemplary aspect, the present disclosure relates to detection of corruption of data used with the OS (e.g., RTOS) program as well as one or more application programs.

### 2. Description of Related Technology

Operating systems (OS) are well known in computerized systems. One species of such operating systems is the so-called Real-Time Operating Systems (RTOS). RTOS programs provide, inter alia, multithreading and other services to embedded applications running on memory and processing constrained devices. In some cases, the code and data of an RTOS program are combined with an application's code and data, resulting in what is commonly called a monolithic image. The code portion of this image is most often located in a non-volatile memory structure such as, e.g., NAND or NOR Flash, which is naturally resistant to corruption. However, the data of both the RTOS and the application is stored (such as in data memory—most often Random Access Memory or RAM) and is susceptible to corruption.

Current measures to limit data corruption—either unintentional or intentional via external hacking—are less than reliable or even ineffective in terms of detecting data corruption. As one example, both the RTOS and application code discussed supra traditionally perform basic sanity checks on data, e.g., checking for NULL pointers. In such checks for NULL pointers, if the data corruption does not write a value of NULL (0) over the pointer in question, the check for NULL pointer is meaningless. Similarly, if a security breach is the cause of the data corruption, it's relatively easy to circumvent the NULL pointer check.

As another example, both RTOS and application code also typically rely heavily on testing—sometimes called code hardening—to reduce the risk of data corruption. Hardening the software—both RTOS and application—is a worthwhile exercise. However, as the code size and complexity increase, the ability to guarantee prevention of all data corruption decreases. Notably, these measures are also directed at prevention of the creation of corrupted data by the code, in contrast with detection of data that has been corrupted. Stated differently, code hardening is ineffective at mitigating errors/corruption which does not result from normal operation or execution of the code, whatever its source.

It is theoretically possible for both RTOS and application code to use digests like SHA to create a digital fingerprint associated with various data elements, which would be helpful in detecting such data corruption. However, the overhead of such digests is prohibitive for, inter alia, real-time, memory and/or processor-constrained systems.

Accordingly, improved apparatus and methods are needed to, inter alia, overcome the aforementioned deficiencies within such computer programs (e.g., an RTOS program) and devices. Such methods and apparatus would advantageously, inter alia, facilitate detection of data corruption in real-time and/or resource constrained devices, and with low overhead.

### SUMMARY

The present disclosure addresses the foregoing needs by providing, inter alia, apparatus and methods for apparatus and methods for enhanced data corruption detection in computer programs such as an OS (e.g., RTOS) program and application program.

In a first aspect of the disclosure, an improved method of enhanced data corruption detection in one or more computer programs is disclosed. In one or more embodiments, the computer program is at least one of (i) an operating system computer program, and/or (ii) an application program. In one variant, the operating system computer program comprises an RTOS program, and the application program is integrated at least partly within the RTOS as part of a monolithic image. This approach facilitates, inter alia, very early detection of data corruption.

In one embodiment, the method includes: 1) building a verification code; 2) storing the built verification code, and 3) verifying the stored verification code.

In one variant, the building and storing of the verification code includes: (i) generating a unique code (also referred to herein as a “secret”); (ii) utilizing the unique code, at least one data value, and a verification code storage address to generate the verification code; and (iii) storing the verification code at the verification code storage address.

In another variant, the verifying of the verification code includes utilizing, subsequent to some execution of the computer program, (i) the unique code, (ii) at least one data value, and (iii) a verification code storage address, to generate the verification code again; and determining whether that generated verification code matches the stored verification code.

In one implementation, if the verification code matches the stored verification code, execution of the computer program continues. However, if the verification code does not match the stored verification code, a system error handler is called to attempt to diagnose and/or rectify the error.

In a second aspect of the disclosure, a computerized embedded apparatus is disclosed. In one embodiment, the computerized embedded apparatus includes: data storage apparatus; processor apparatus in data communication with the storage apparatus; and storage apparatus in data communication with the processor apparatus.

In one variant, the storage apparatus includes at least one computer program having a plurality of instructions, where the plurality of instructions are implemented to, when executed by the processor apparatus, cause the computerized apparatus to: execute an RTOS program, the execution of the RTOS program including execution of a low-complexity verification algorithm, the low-complexity verification algorithm (i) including at least one of temporal properties or spatial properties, and (ii) implemented to rapidly detect data corruption within a threshold amount of time relative to commencement of the execution of the RTOS program.

In one implementation, the execution of the low-complexity verification algorithm includes, during a first period of time relative to commencement of the execution of the RTOS program: generation of a first unique identifier; utilization of the first unique identifier to generate a first verification variable; and storage of the verification variable at a storage location.

In one example, the generation of the first unique identifier includes generation of the first unique identifier via use of a hardware true random number generator (TRNG).

In another example, the generation of the first unique identifier includes assignment of the first unique identifier to a pointer; and the execution of the low-complexity verification algorithm further includes utilization of the pointer to determine an address of the storage location used to store the first verification variable.

In one particular example, the low-complexity verification algorithm includes an equation comprising a sum of (i) values associated with data of the RTOS program, (ii) the address of the storage location, and (iii) the first unique identifier, which is squared by the first unique identifier.

In another particular example, the execution of the low-complexity verification algorithm further includes, during a second period of time relative to commencement of the execution of the RTOS program, the second period of time being after the first period of time: generation a second unique identifier via utilization of the pointer; utilization of the second unique identifier to generate a second verification variable; and determination of whether the first unique identifier matches the second verification variable.

In a third aspect of the disclosure, a computer readable apparatus is disclosed. In one embodiment, the computer readable apparatus includes a non-transitory storage medium, the non-transitory storage medium including at least one computer program having a plurality of instructions.

In one variant, the plurality of instructions are implemented to, when executed by a processing apparatus, cause a computerized apparatus to: utilize a low-complexity verification algorithm to generate an initial data value associated with data of an application program and detect corruption of at least one of (i) the initial data value or (ii) a storage address of the initial data value.

In one implementation, the low-complexity verification algorithm includes four (4) assembly instructions. In one example, the four (4) assembly instructions includes: (i) a load instruction; (ii) an add instruction configured to adds register values; (iii) an exclusive OR (XOR) instruction subsequent to the execution of the add instruction, the XOR instruction configured to complete a computation of a value, and (iv) a store instruction to store the computed value in a register.

In another implementation, the initial data value is utilized as a verification fingerprint for data relating to at least one of: (i) function pointers, (ii) function return address, (iii) stack corruption, or (iv) linked-list and general pointer corruption.

In yet another implementation, the application program is stored in random access memory (RAM) of the computerized apparatus.

In yet another implementation, the detection of the corruption of the at least one of (i) the initial data value or (ii) the storage address of the initial data value, is based on a plurality of iterations of generating other data values and comparing the other data values to the initial data value.

In a fourth aspect of the disclosure, an improved integrated circuit (IC) apparatus is disclosed. In one embodiment, the IC includes one or more processor cores, and comprises an embedded device utilizing an RTOS having instructions configured to utilize one or more verification codes to detect data corruption during application execution, such as in support of mutex, multi-thread, pointer, queue, or other operations.

In a fifth aspect of the disclosure, an improved method of hashing data is disclosed. In one exemplary embodiment, the method includes use of a low-complexity hashing algorithm, including in one variant a low number (e.g., 4) of assembly instructions.

In one embodiment, the low-complexity hashing algorithm comprises an algorithm in which the hash is based on (i) a data value, (ii) an address where the hash is stored, and (iii) secret data. In one implementation, the algorithm comprises the formula: Hash=((Data Value)+(Address to Store Hash)+(Secret)) A (Secret). However, in some variants, the foregoing algorithm is customizable (e.g., on a per case/application basis). For example, in some implementations, the algorithm comprises the formula: Hash=((Data Value)+(Address to Store Hash)) A (Secret).

In one implementation, the verification code or hash has both differentiable temporal and spatial properties relating to the instruction execution (cycle) on which it is used, and the memory location(s) where it is stored (which is part of the hash itself), respectively. However, in other implementations, the code/hash has just one of temporal and spatial properties.

In a sixth aspect of the disclosure, a non-transitory computer readable apparatus is disclosed. In one embodiment, the apparatus comprises a program memory (e.g., ROM or Flash) of an embedded device, and includes logic (e.g., executable instructions) configured to allow an RTOS of the embedded device to build/store one or more verification codes, and verify the one or more verification codes.

In a seventh aspect of the disclosure, methods of using one or more verification codes as a verification fingerprint for important data in one or more OS-based applications. In one embodiment, the one or more OS-based applications utilize data verification in relation to one or more of (i) function pointers, (ii) function return address, (iii) stack corruption and/or memory buffer corruption, or (iv) linked-list and general pointer corruption.

In one variant, the method includes: (i) setting up function pointers; (ii) storing the function pointers in memory (e.g., RAM); and (iii) and utilizing a verification code for the function pointers to determine if the function pointers are corrupted.

In an eighth aspect of the disclosure, methods of system error handling are disclosed. In one embodiment, the methods include calling a system error handler to facilitate troubleshooting, error correction, or debug by a programmer or support entity.

These and other aspects shall become apparent when considered in light of the disclosure provided herein.

### BRIEF DESCRIPTION OF THE DRAWINGS

FIG. 1 is a logical block diagram of an exemplary embodiment of a method for providing enhanced data corruption detection, and optional remediation, of a program (e.g., RTOS and/or application program), in accordance with various aspects of the present disclosure.

FIG. 1A is a logical block diagram of an exemplary embodiment of a method for building and storing the verification code, in accordance with various aspects of the present disclosure, and more specifically, with the exemplary methodology of FIG. 1.

FIG. 1B is a logical block diagram of an exemplary embodiment of a method for verifying the verification code, in accordance with various aspects of the present disclosure, and more specifically, with the exemplary methodology of FIG. 1.

FIG. 2 is a graphical representation of one implementation of the exemplary methodology of FIG. 1, wherein a low-complexity verification code and corresponding four (4) assembly language instructions required for implementation thereof in an exemplary ARM Cortex-M processor environment, are utilized.

FIG. 3 is a graphical representation of one exemplary C code implementation of functions for generating, storing, and verifying a verification code, in accordance with various aspects of the present disclosure, and more specifically, with the exemplary methodology of FIG. 1.

FIG. 4 is a logical block diagram of an exemplary embodiment of a method for providing enhanced data corruption detection to, inter alia, verify a valid function pointer before it is dereferenced, in accordance with various aspects of the present disclosure.

FIG. 5 is a graphical representation of one implementation of verification code 500 used before using an exemplary “thread_entry_routine” function pointer (to call the “my_thread_entry” function), in accordance with various aspects of the present disclosure, and more specifically, with the exemplary methodology of FIG. 4.

FIG. 6 is a logical block diagram of an exemplary method for providing enhanced data corruption to, inter alia, verify a function return address, in accordance with various aspects of the present disclosure.

FIG. 7 is a logical block diagram of an exemplary method for providing enhanced data corruption to, inter alia, detect one or more stack corruptions, in accordance with various aspects of the present disclosure.

FIG. 8 is a graphical representation of one implementation of verification code 800 used to detect corruption of a thread stack frame in an exemplary function “stack checking example”, in accordance with various aspects of the present disclosure, and more specifically, with the exemplary methodology of FIG. 7.

FIG. 9 is a logical block diagram of an exemplary method for providing enhanced data corruption to, inter alia, detect corruption of significant function pointers, in accordance with various aspects of the present disclosure.

FIG. 10 is a graphical representation of one implementation of verification code 1000 to detect corruption of an exemplary “created_threads_pointer” before it is used, in accordance with various aspects of the present disclosure, and more specifically, with the exemplary methodology of FIG. 9.

FIG. 11 illustrates one exemplary embodiment of an enhanced data corruption detection architecture, implementing various aspects of the present disclosure.

FIG. 12 illustrates one exemplary embodiment of an enhanced data corruption detection apparatus, implementing various aspects of the present disclosure.

### DETAILED DESCRIPTION

Reference is now made to the drawings wherein like numerals refer to like parts throughout.

As used herein, the term “application” (or “app”) refers generally and without limitation to a unit of executable software that implements a certain functionality or theme. The themes of applications vary broadly across any number of disciplines and functions (such as on-demand content management, e-commerce transactions, brokerage transactions, home entertainment, calculator etc.), and an application may have more than one theme. The unit of executable software generally runs in a predetermined environment. For example, a processor apparatus may obtain and execute instructions from a non-transitory computer-readable storage medium where the instructions are compiled for the processor.

As used herein, the term “computer program” or “software” is meant to include any sequence or human or machine cognizable steps which perform a function. Such program may be rendered in virtually any programming language or environment including, for example and without limitation, C/C++, Fortran, Java™ (including J2ME, Java Beans, etc.), Register Transfer Language (RTL), VHSIC (Very High Speed Integrated Circuit) Hardware Description Language (VHDL), Verilog, and the like. Such computer programs or software can be divided into pieces, commonly called “tasks” or “threads,” and each thread may retain its own copy of the contents of executed resources as if they were the thread's own private resources (i.e., a thread's “context”).

As used herein the terms “C” and “C programming language” refer without limitation to ANSI C, C #, C++, and/or Objective-C, as well as other “C family” languages such as for example Python, Java, JavaScript, Perl, PHP, Verilog, D, Limbo and C shell of Unix.

As used herein, the term “memory” includes any type of integrated circuit or other storage device adapted for storing digital data including, without limitation, read-only memory (ROM), programmable ROM (PROM), electrically erasable PROM (EEPROM or E2PROM), random access memory (RAM), dynamic RAM (DRAM), synchronous dynamic RAM (SDRAM) including double data rate (DDR) class memory and graphics DDR (GDDR) and variants thereof (e.g., DDR/2 SDRAM), ferroelectric RAM (FeRAM), magnetic RAM (MRAM), resistive RAM (RRAM), reduced-latency DRAM (RLDRAM), static RAM (SRAM), magnetoresistive RAM (MRAM), such as spin torque transfer RAM (STT RAM), “flash” memory (e.g., NAND/NOR), 3D memory, and pseudostatic RAM (PSRAM). Extended Data Out Fast Page Mode (EDO/FPM) memory, phase change memory (PCM), and 3-dimensional cross-point memory (3D Xpoint).

As used herein, the terms “microprocessor” and “processor” or “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), programmable logic devices (PLDs), reconfigurable computer fabrics (RCFs), array processors, secure microprocessors (i.e., physically secure micros), and application-specific integrated circuits (ASICs). Such digital processors may be contained on a single unitary IC die, or distributed across multiple components. As used herein, the term “interface” refers to any signal or data interface with a component or network, whether, wireline, optical, or wireless, including without limitation those of the Thunderbolt, FireWire (e.g., FW400, FW800, etc.), USB (e.g., USB 2.0, 3.0., 3.1, 3.2, 4, OTG), Ethernet (e.g., 10/100, 10/100/1000 (Gigabit Ethernet), 10-Gig-E, etc.), Wi-Fi (IEEE Std. 802.11 WLAN), cellular data (e.g., 5G NR, LTE, 3G), Bluetooth/PAN, IEEE Std. 802.15, ZigBee, LoRAWAN, Infrared (IR), or other.

As used herein, the term “Real-Time Operating System” or “RTOS” refers without limitation to system software that provides multithreading services to embedded applications running on memory and processing constrained devices. More specifically, RTOSes allocate processing time among various duties that the embedded software must perform, typically by dividing the software into portions, commonly called “tasks” or “threads,” and creating a run-time environment that provides each thread or task with its own virtual microprocessor (i.e., “multithreading”). Examples of the RTOS may include, without limitation, Azure RTOS ThreadX™ provided by Microsoft®, Nucleus RTOS™ provided by Siemens®, Versatile Real-Time Executive (VRTX) provided by Mentor Graphics®, Operating System Embedded (OSE)™ provided by Enea®, FreeRTOS, REX OS provided by Qualcomm®, OKL4 provided by Open Kernel (OK) Labs®, or any other suitable RTOS.

As used herein, the term “resource” refers in one context to a hardware or software unit that is provided by a computing device, including, without limitation, processor cycles, processor time, memory including memory capacity, peripherals, interrupts, network bandwidth, video frame buffers, and sound cards.

As used herein, the term “virtual microprocessor” is meant generally to include any type of processing of a virtual set of microprocessor resources including, without limitation, a register set, program counter, stack memory area, and a stack pointer.

### Overview

In one salient aspect, the present disclosure provides apparatus and methods for, inter alia, enhanced data corruption detection, such as within a “monolithic” OS (e.g., RTOS) and application program environment associated within an embedded device.

In one exemplary embodiment described herein, a verification code (which can take the form of e.g., a hash or digest) is used to help detect data corruption, including within real-time and/or resource constrained devices. In one variant, the verification code can be created or implemented with as few as four (4) assembly instructions, which advantageously translates to low processing overhead and latency/resource consumption.

In one variant, the verification code is configured to possess either or both of temporal properties and spatial properties which can be used to advantage. Specifically, the temporal properties stem from differences created on each execution of the software (assuming the supplied “secret” used to form the code is unique on each software execution). In one particular configuration, the secret is derived from a hardware True Random Number Generator (TRNG) on or in data communication with the embedded device.

Additionally, the verification code spatial properties allow for differentiation; specifically, an address used to store the code is also used to form the code, thereby guaranteeing code diversity as a function of spatial storage location.

The exemplary low-complexity verification code advantageously has some properties of secure hashes (such as an SHA-class digest) such as, e.g., collision resistance, pre-image resistance, and second pre-image resistance (one-way hash).

In yet another variant, the verification code of the present disclosure can be used as a verification fingerprint for any important data, including, without limitation, function pointers, function return address, stack corruption, memory buffer corruption, linked-list and general pointer corruption, etc.

The method and apparatus for enhanced data corruption detection of the present disclosure represent a significant enhancement in detecting data corruption as early as possible relative to execution of code on the e.g., embedded device, thereby maximizing mitigation of any damage caused by such corrupted data (whether intentionally or unintentionally corrupted). Moreover, finding the data corruption early also advantageously makes isolating the source of the corruption easier.

### DETAILED DESCRIPTION OF EXEMPLARY EMBODIMENTS

Exemplary embodiments of the apparatus and methods of the present disclosure are now described in detail. While these exemplary embodiments are described in the context of the C program language, other types of programming languages—including, without limitation, Java™, Register Transfer Language (RTL), VHSIC (Very High Speed Integrated Circuit) Hardware Description Language (VHDL), Verilog, and the like—may be used consistent with the present disclosure.

Other features and advantages of the present disclosure will immediately be recognized by persons of ordinary skill in the art with reference to the attached drawings and detailed description of exemplary embodiments as given below.

### Exemplary Methods and Verification Code-

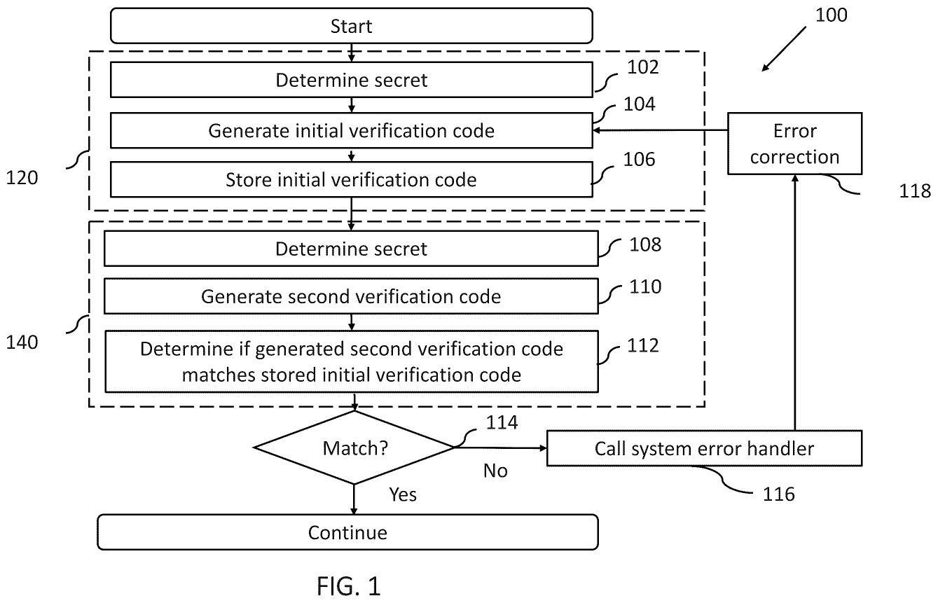

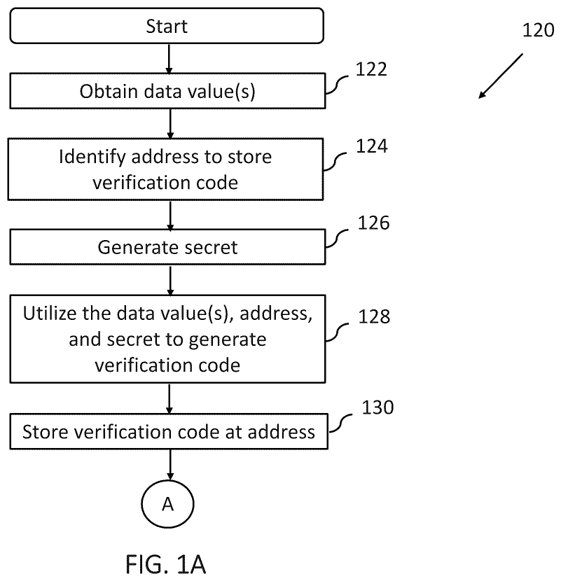

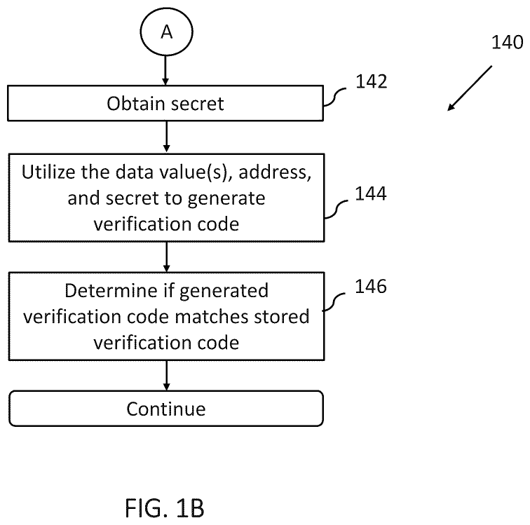

Referring now to FIG. 1, one exemplary embodiment of a generalized method 100 for providing enhanced data corruption detection of a program (e.g., RTOS and/or application program) in accordance with the present disclosure is described.

At step 102, a secret is obtained. In one variant, the secret is any unique identifier which is unique during a prescribed number of execution cycles or events, such as during each execution of a given program or sub-part thereof. In one implementation described in greater detail subsequently herein, the secret is derived from a hardware true random number generator (HRNG or TRNG), which is device that generates random numbers from a physical process, rather than via an algorithm. Use of a TRNG is advantageous for at least the reason that it would be more difficult for a hacker to intentionally corrupt memory with bad data but good verification codes. More pointedly, the less truly random the secret, the easier it would be for a hacker to create more accurate verification codes (although, according to the various embodiments of the present disclosure that include storage location address(es) in the algorithm, a hacker would need to know those storage locations as well). However, the present disclosure contemplates use of any “unique” code generator that is well known in the art to generate the secret or unique code, including without limitation PRGs (pseudo-random generators), including those which operate in whole or part based on such algorithms.

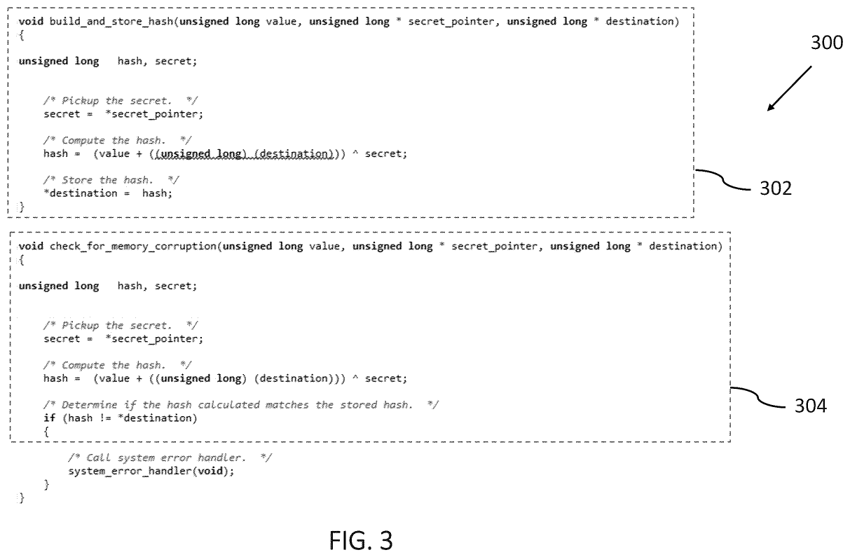

Additionally, in one variant, the generation of the secret includes assigning the secret to a pointer. For example, in one implementation, the instruction required to implement it in ARM Cortex-M assembly language is “secret=*secret_pointer;” (as shown in FIG. 3 discussed below).

At step 104, a verification code is generated. As described elsewhere herein, in one implementation, the algorithm used to generate the verification code is as follows:

Verification Code=((Data Value(s))+(Address to Store Verification Code)+(Secret))\hat{ }(Secret) Eqn. (1)

Advantageously, this exemplary verification code or digest comprises a low-overhead approach that enables detection of data corruption, including in real-time and/or resource constrained devices, such as embedded RTOS-based systems.

Additionally, it is appreciated that, in accordance with the various embodiments of the present disclosure, the verification code of Eqn. (1) can be adjusted on a per case/application base, to be simpler or more complicated. For example, in one implementation, if lower overhead is desired, the following simplified algorithm could be used:

Verification Code=((Data Value(s))+(Address to Store Verification Code))\hat{ }(Secret) Eqn. (2)

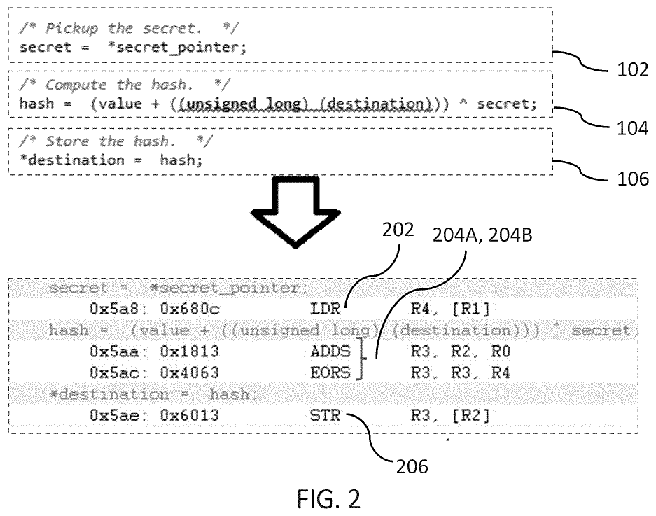

With respect to Eqn. (2) in comparison with Eqn. (1), adding the secret to the sum is not necessary to maintain the temporal and spatial properties associated with the algorithm, as explained in further detail elsewhere herein (see, e.g., the description for FIG. 2 infra), and therefore, it can be removed to simplify the algorithm while the algorithm still maintains those temporal and spatial properties.

The adjustment/modification of the algorithm (such as those provided in the present disclosure) can be implemented via use of, e.g., a macro (e.g., a C macro) that the application developer can customize according to their preferences.

At step 106 of the method 100, the verification code is stored. In one variant, the verification code is stored in one or more data memories (e.g., RAM). It will be appreciated that while a unitary storage location (i.e., a single address) is used in one embodiment, the disclosure is in no way so limited, and in fact the code can be distributed across two or more storage locations (e.g., a range of addresses) and/or devices.

Additionally, in some embodiments, there can be a relationship between the storage location of the data itself (i.e., that which is being verified) and the storage location of the verification code. More specifically, although not a requirement, there are advantages to storing the verification code in a location or locations having a known relationship to the storage locations of the actual data itself. For example, storing the verification code storage adjacent to the pointer or data being verified makes it easier to locate the verification code for various functions, such as cache access and debug.

However, in other embodiments, the verification code(s) can be located separately from the data/pointers. For example, for security-focused distributions, it would be more difficult for a hacker to intentionally corrupt a function pointer and verification code if they are located in separate memory locations. Position-independent code (PIC) or position-independent executable (PIE), for example, can be used to read/write verification code(s) separately from the data/pointers or effect address space layout randomization.

Yet additionally, it will be appreciated that the verification code can be any size. For example, a verification code could be generated to be 32-bits in length, 64-bits, or any other size.

Referring back to FIG. 1, steps 102, 104, and 106 can be collectively referred to herein as the “build and store” process 120, which represents the creation and storage of the verification code (on any given iteration).

Next—for example, after at least a portion of the program (e.g., RTOS and/or application program) has been executed—the method 100 continues to the verification process 140 to check for corrupted data (from whatever source or whatever reason) via verification of the code/hash.

Verification process 140 starts with step 108, where the secret is obtained. For example, in one variant, the secret can be obtained using the pointer assigned per step 106. In one implementation, the instruction required to implement the pickup of the pointer (in the exemplary ARM Cortex-M assembly language context) is “secret=*secret_pointer” (as shown in FIG. 3).

At step 110, a verification code is generated. In the illustrated embodiment, the algorithm used per step 110 is the same algorithm used per step 104.

Then, per step 112, it is determined whether that verification code generated per step 110 matches the stored verification code. For instance, in one variant, the contents of the stored verification code are loaded intro a first register, the generated code (step 110) is loaded into a second register, and a “compare” instruction/function is used to determine any difference.

If a match is determined (per step 114), normal processing of the program (e.g., RTOS and/or application program) continues.

However, if a match is not found (per step 114), a system error handler is called (per step 116), and designated logic (such as the application itself) chooses what to do next. For example, in the variant shown in method 100, the data value(s) can optionally be modified (per step 118) to, e.g., correct or update the corrupted data. Alternatively (or in parallel), one or more analytic routines may be invoked in order to attempt to divine the cause or source of the error.

The system error handler alerts the system that there is a fatal error. The application may override the default processing which would basically be a reset.

The method can then, in one case, return to step 104 to generate a verification code with the modified data value(s). That is, after intended modification of any data covered by the hash, a new hash based on the corrected value must be created and stored. The program can proceed without verification of this new value, or alternatively the relevant portions of the method 100 can again be invoked to determine stored code data validity (e.g., if there is an error in a “write” or similar process, this can be at least putatively identified by re-running the verification again after the corrected data is stored, which would again yield an invalid result).

Referring now to FIG. 1A, one exemplary implementation of the method 120 for building and storing the verification code is described.

As shown, per step 122, one or more data values are obtained. For example, in one variant, the data values can be included in source code provided to a programmer, or obtained from a data storage device or location such as a register or memory address.

At step 124, an address where the verification code is be stored is identified. Each data element that is to be verified must have specific verification code storage location data associated therewith. In one variant, one “unsigned long” data element “value” is obtained to be hashed (i.e., a verification code generated therefor). However, it will be appreciated that 1) the verification code can be extended over multiple data values (e.g., two or more values are constituent parts of a single hash), and 2) a given data value to be verified can be partitioned into two or more components, each of which is assigned its own unique verification code), in accordance with various implementations of the present disclosure.

At step 126, a secret is generated, as described with respect to various embodiments elsewhere herein.

At step 128, the obtained data value(s), address, and secret are utilized to generate a verification code.

At step 130, the verification code is stored at the address identified per step 124.

It can be appreciated that steps such as 122, 124 and 126 (and in fact other steps in the generalized method 100) can be performed in other order(s), including with portions of the method operating in parallel/concurrently. For example, the address(es) associated with storage of the generated code may be generated first, followed by obtaining the data values to be stored. The secret may also be generated (e.g., first, or in parallel with the obtainment of the data and/or the address) before the verification code is generated. Parts of the verification code calculation can also feasibly be performed while awaiting the remainder of the constituent components needed; e.g., the address and data value can be summed before the secret is obtained), depending on how the code executing the given implementation is structured (see, e.g., the example code of FIG. 2). Various other permutations will be recognized by those of ordinary skill given this disclosure. Moreover, the various steps of the method(s) 100, 120 can comprise two or more constituent operations.

Now referring to FIG. 1B, one exemplary implementation of the method 140 for verifying the previously generated verification code is described. It is evident that the performance of the verification 140 does not necessarily have to occur immediately after the generation and storage of the verification code per the method 120; while the verification method 140 verifies the integrity of the data as previously discussed, such verification can be performed feasibly at any time after generation and storage of the original verification code. For example, the verification process 140 can be started at some prescribed time after at least a portion of the program (e.g., RTOS program and/or application program) has been executed, based on the occurrence of one or more events, or in anticipation of execution of an operation or routine execution. Various other scenarios on when the verification is implemented will be appreciated by those of ordinary skill given the present disclosure. While “immediate” verification as shown in the method of FIG. 1 is often desirable so as to isolate/catch any errors or corruption at an early stage, there may in fact be instances where the verification can be conducted more efficiently (e.g., with less impact on overhead consumption, latency, etc.) than others. Hence, the present disclosure contemplates optimization of the verification event based on e.g., analysis of the flow and execution of the code as a whole, and/or other parameters or considerations.

At step 142, the secret is obtained (e.g., from the previous generated secret value used in the verification code generation process 120, which can be stored in a memory, register, etc.).

At step 144, the secret, data value(s) and address are utilized to generate a verification code. The data value(s) and address are known from steps 102 and 104, respectively. The data value(s) and address should be the same unless either is corrupted and/or modified. It will be recognized that corruption of any of (i) the original data value, and/or (ii) the storage address of the original verification code, will produce a different verification code in the method 140 versus that of the method 120. Stated differently, the methods described herein advantageously can detect either a corruption of the original data which is the subject of the verification process, or the code storage address (such as where a surreptitious process attempts to alter the address by rewriting to a new memory location).

At step 146, a determination of whether the generated verification code matches the stored verification code, is made. For example, the generated verification code can be compared to the stored verification code to determine if the codes match, as previously described. Data corrupted is detected based on the codes not matching (in this instance, having any deviation or difference between them). Any deviation or different between the verification codes means that the data/pointer was corrupted.

Referring now to FIG. 2, use of one exemplary embodiment of a low-complexity verification code and corresponding four (4) assembly language instructions required to implement the methodology of FIGS. 1A and 1B (in an exemplary ARM Cortex-M assembly language context), is shown and described.

As shown, in the exemplary embodiment of FIG. 2, the low-complexity verification code algorithm of Eqn. (1) discussed previously herein is used, specifically as follows:

Verification Code=((Data Value)+(Address to Store Verification Code)+(Secret))\hat{ }(Secret) Eqn. (1)

The corresponding pseudo-code representations for portions of the methodology 120 of FIG. 1 are shown; i.e., the obtainment of the secret 102, computation of the hash 104, and storage of the computed hash 106. These steps are implemented in the target platform assembly language as four instructions, namely: (i) a “load” instruction (e.g., from a prescribed register) 202, (ii) an “add” instruction 204a which adds register values, (iii) an exclusive OR (XOR) instruction (204b, subsequent to the execution of the add) which completes the computation of the hash or verification code, and (iv) a “store” instruction 206 to store the computed value in a register.

The exemplary verification code or digest shown in FIG. 2 is a simple hash function that provides meaningful data corruption capabilities, while only adding four (4) assembly language instructions 202, 204a, 204b, and 206 of overhead to calculate. Of course, the overhead applies to creating the hash, and then again each time the hash is used for verification; however, with a net overhead of four instructions, the verification can be performed multiple times during program execution while having little impact in the aggregate.

Artisans of ordinary skill in the related arts given the contents of the present disclosure will readily appreciate that the foregoing exemplary verification code algorithm is purely illustrative; various considerations may be considered in determining acceptability of operation. Specifically, more complicated verification code algorithms can be created; however, the more complicated the verification code algorithm the less practical for real-time and/or resource constrained systems. Different inputs that the data, address, and secret shown (or combinations thereof) may also be used, with the illustrated algorithm being but one possibility.

As explained elsewhere herein, in accordance with various embodiments of the present disclosure, the exemplary verification codes, such as that of Eqn. (1), can be customized by having the algorithm in a macro (e.g., a C macro) that an application developer or programmer can personalize according to user preferences.

Additionally, the exemplary verification code of Eqn. (1), advantageously has (i) temporal properties, in that it should be different on each execution of the software (assuming the secret supplied is unique on each software execution), and (ii) spatial properties, in that the verification code of same data value(s) stored in different memory locations will be different because the address to store the verification code is also part of the verification code. These features can be leveraged (and in fact adjusted) to provide the maximum degree of protection with the minimum amount of overhead, as will be appreciated by those of ordinary skill given the present disclosure.

In other words—although a verification code having both of the spatial and temporal dimensions will stronger (i.e., more difficult to hack) in at least most cases—in some embodiments, the verification algorithm can be created/adjusted on a per case/application basis to leverage just one of these dimensions. For example, given that the verification code will be unique due to the storage address (i.e., the verification code having spatial properties), the temporal property of the verification code can be foregone by using the same secret on multiple iterations. Conversely, the verification algorithm can forego use of the storage address (i.e., forego the spatial properties), relying on only the temporal aspect by using different secrets on multiple iterations. TRNG would be especially beneficial in the algorithms not having the spatial aspect, as it generates a more truly random secret (relative to, e.g., a pseudo-random number generator), and therefore a harder secret for bad actors or hackers to determine.

However, a verification code having the spatial aspect without the temporal aspect would generally be more difficult to reverse engineer than a verification code having the temporal aspect without the spatial aspect. is more important than the temporal. More pointedly, if only the secret (temporal) is used, then the same pointer/data value will have the same verification code. By using the verification code storage address (spatial), the same pointer/data will have different verification codes for every instance.

Additionally, while not as robust as e.g., an SHA-class digest, the verification codes provided in the present disclosure advantageously retain some properties of secure hashes, e.g., collision resistance, pre-image resistance, and second pre-image resistance (one-way hash), and as such represents a good “compromise” between a more robust high-overhead approach, and operation with no corruption detection mechanisms such as in a purely code-hardened approach.

Yet additionally, as is discussed in greater detail hereinafter, this data corruption detection verification code can be used as a verification “fingerprint” of sorts for any important data in an RTOS-based application, including, without limitation:
1. Function Pointers. Function pointers are setup and stored in e.g., RAM. If they are corrupted, the program execution is undefined. Perhaps even worse, hackers often try to intentionally exploit function pointer corruption to inject malicious code execution. By detecting the corruption early enough, the execution failure/code execution mis-direction can be avoided.
2. Function Return Address. The return addresses of C functions are somewhat analogous to function pointers. Corruption of the return address can result in undetermined behavior. This too is a common target of hackers, and such attacks can be blunted by early-stage data verification.
3. Stack and Memory Corruption. Stack overflow and buffer overflow are very common memory corruption scenarios in real-time, RTOS based systems, and can be avoided via early detection of corruption.
4. Linked-list and general pointer corruption. All linked-list processing is susceptible to data corruption.

The verification code according to various aspects of the present disclosure can be applied to each of the aforementioned areas, among others.

FIG. 3 is a graphical representation of one exemplary C code listing 300 of functions for generating and verifying the verification code, in accordance with the exemplary methodology of FIG. 1, described supra.

As shown in FIG. 3, the exemplary C code 300 includes functions or routines for building and storing the verification code 302, and checking for data corrupt via verification of the verification code 304.

These C functions can advantageously be instantiated “in-line” within a given program flow, so as to avoid any function call and/or return overhead. As the code illustrates, each data element that is to be verified must have a specific hash storage location. As previously discussed, the hash may be readily extended over multiple values (or conversely, the data partitioned to be subject to multiple respective hashes), but for the sake of simplicity the exemplary C code structure 300 assumes one “unsigned long” data element “value” to be hashed.

Additionally, as explained elsewhere herein, the data corruption detection verification code can be used as a verification fingerprint for any important data in RTOS-based applications, including without limitation: (i) function pointers, (ii) function return address, (iii) stack corruption, and (iv) linked-list and general pointer corruption. Each of these exemplary applications are explained infra.

### Function Pointers-

As noted above, function pointers are setup and typically stored in memory (e.g., RAM). If they are corrupted, the program execution is undefined. Additionally, hackers often try to intentionally exploit function pointer corruption to inject malicious code execution.

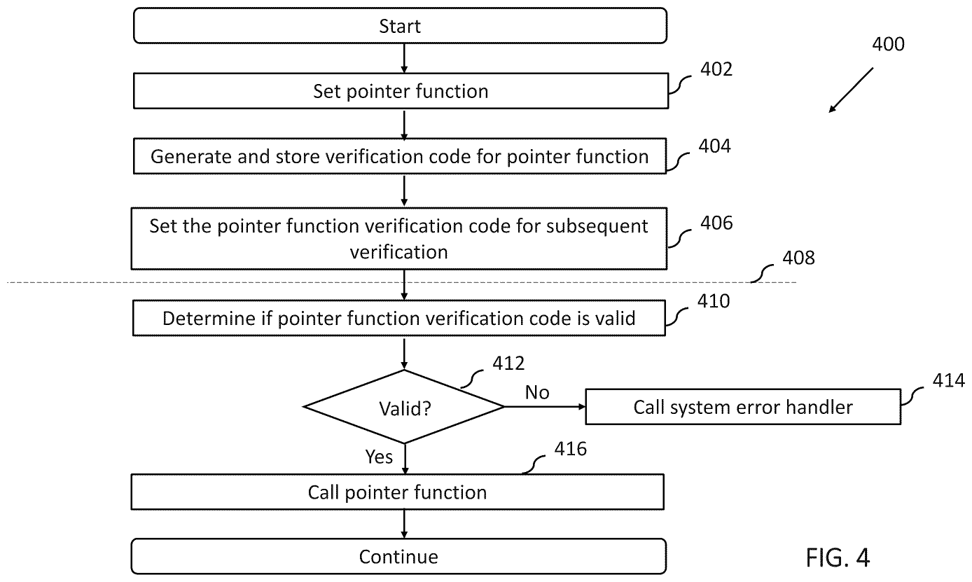

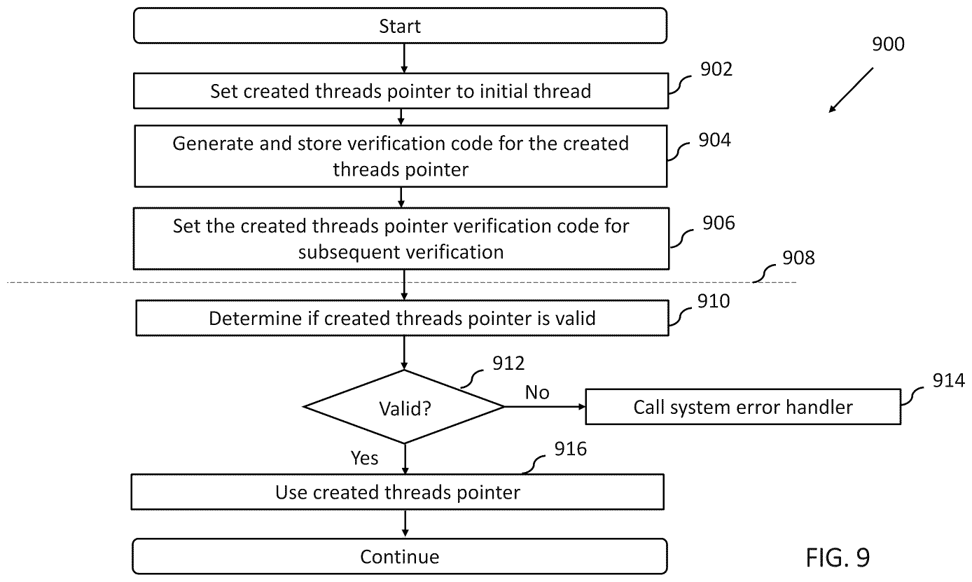

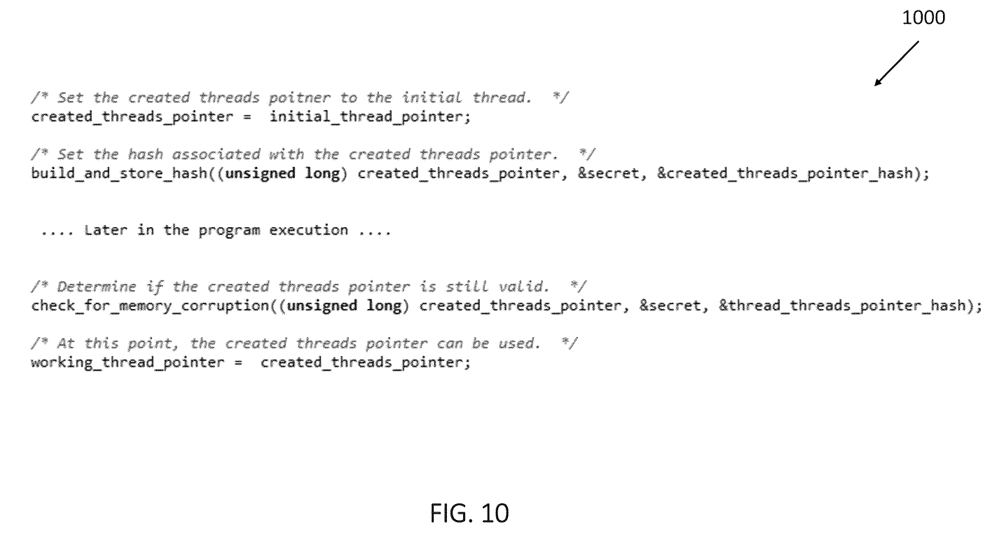

Referring now to FIG. 4, one exemplary embodiment of a method 400 for providing enhanced data corruption detection to, inter alia, check for a valid function pointer before it is de-referenced, is described. Additionally, it is appreciated that a similar approach can be used to verify the function return address, as shown in FIGS. 9 and 10 described infra—the return address verification code would be created at the beginning of the function, and then verified prior to the function returning.

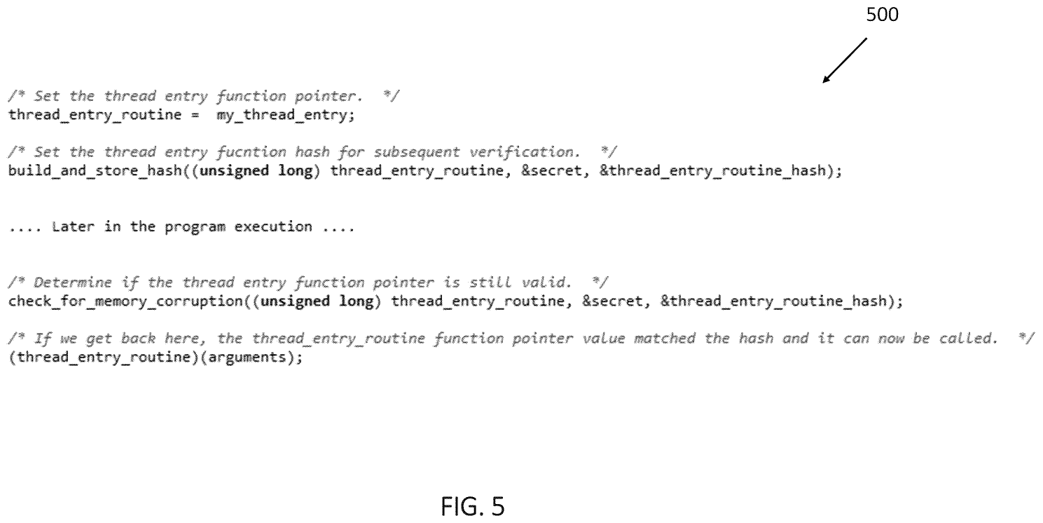

At step 402 of the method 400, a pointer function is set. For example, in one exemplary variant, a thread entry (e.g., “my_thread_entry”) can be set to a thread entry function pointer (e.g., “thread_entry_routine”), as shown in the exemplary code 500 shown in FIG. 5 described infra.

At step 404, a verification code for the pointer function is generated and stored. In one embodiment, the following algorithm of Eqn. (3) is used:

Verification Code=((Pointer value(s))+(Address to Store Verification Code)+(Secret))\hat{ }(Secret) Eqn. (3)

However, as described in detail elsewhere herein, the verification code algorithm, such as that of Eqn. (3), can be customized/modified. For example, the secret as part of the sum could not be utilized, or only the address and secret could be utilized, etc. depending on the context.

At step 406, the pointer function verification code is set for subsequent verification. For example, in the exemplary code 500 shown in FIG. 5 described infra, the thread entry function verification code can be set to “build and store hash((unassigned long) thread_entry_routine, &secret, &thread_entry_routine_hash).”

At step 408, at least a portion of the program (e.g., RTOS program and application as part of monolithic image) can be executed.

At step 410, a determination of whether the pointer function verification code is valid is made. For example, in the exemplary code shown in FIG. 5 described infra, the verification determination can be made by the instruction “check for memory corruption((unassigned long) thread_entry_routine, &secret, &thread_entry_routine_hash).”

If the pointer function verification code is determined to not be valid (per step 412), the system error handler is called per step 414.

Alternatively, if the pointer function verification code is determined to be valid (per step 412), the pointer function can be called per step 416. For example, in the exemplary code shown in FIG. 5 described infra, the thread entry routine function pointer can be called by “(thread_entry_routine)(arguments).”

FIG. 5 is a graphical representation of one exemplary implementation of verification code 500 before using the “thread_entry_routine” function pointer to call the “my_thread_entry” function. According to this implementation, the data corruption verification code is used to check for a valid function pointer before it is de-referenced, thereby obviating any wasted overhead on making an inoperative call, or avoiding a pointer mis-direction to a malicious routine or program.

### Function Return Address-

Corruption of the return address can result in undetermined behavior. This too is a common target of hackers.

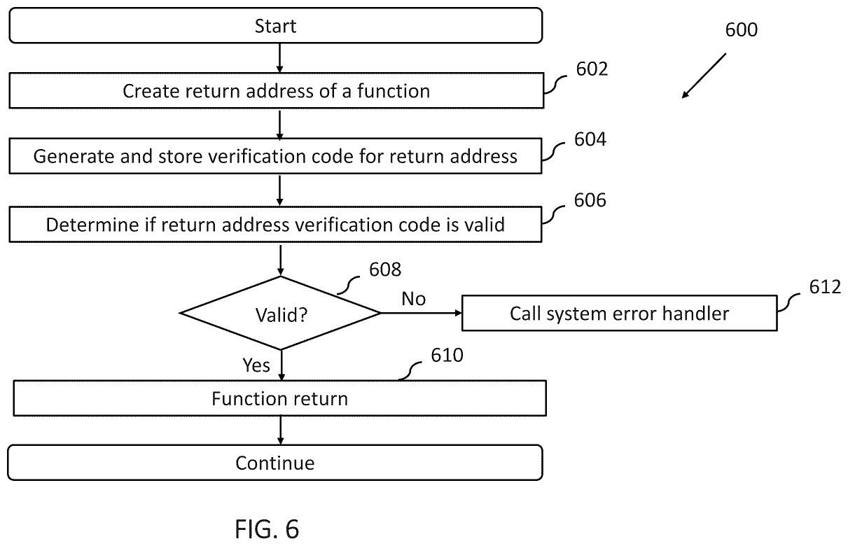

Referring now to FIG. 6, one exemplary embodiment of a method 600 for verifying a function return address, in accordance with the present disclosure is described. The return addresses of C functions are somewhat analogous to function pointers (see FIG. 4).

At step 602, a return address of a function is created. In one embodiment, the algorithm of Eqn. (4) is used:

Verification Code=((Return address))+(Address to Store Verification Code)+(Secret))\hat{ }(Secret) Eqn. (4)

The exemplary algorithm of FIG. 4 has both spatial and temporal properties; however, it is appreciated that, in other embodiments, a different algorithm can be used—e.g., a simplified version which does not utilize the secret as part of the sum, or one that has spatial properties but not temporal properties, and vice versa.

At step 604, the return address verification code is created at the beginning of the function, a determination of whether the return address verification code is valid is made per step 606, and then verified 608 prior to the function returning 610.

If the return address verification code cannot be verified per step 608, a system error handler can be called per step 612.

### Stack and Buffer Corruption-

Stack overflow and buffer overflow are a very common memory corruption scenarios in real-time, RTOS based systems.

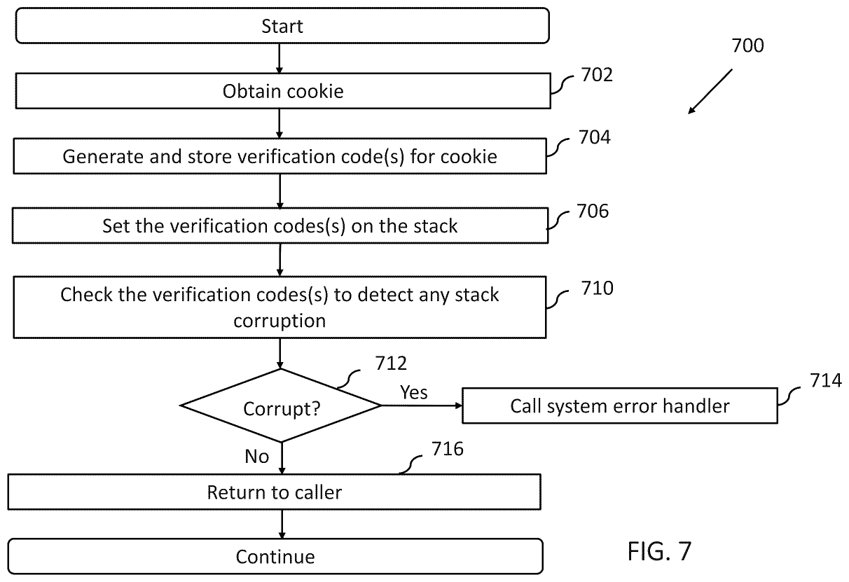

Referring now to FIG. 7, one exemplary embodiment of a method 700 for providing enhanced data corruption within a stack, in accordance with the present disclosure is described.

At step 702, one or more cookies are obtained.

At step 704, one or more verification codes for the one or more cookies are generated and stored. In one embodiment, the algorithm of Eqn. (5) is used:

Verification Code−((Cookie data))+(Address to Store Verification Code)+(Secret))\hat{ }(Secret) Eqn. (5)

In various other embodiments, a different verification could be utilized, such as one that does not utilize the secret as part of the sum, one that has spatial properties but not temporal properties, or one that has temporal properties but not spatial properties.

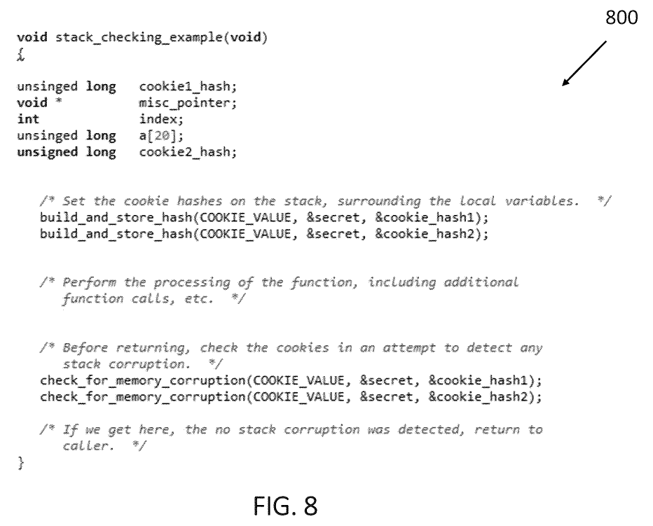

At step 706, the verification code(s) is/are set on the stack. In one variant, a verification code value of a “cookie” is placed at the top and at the bottom of the local stack frame (as shown in FIG. 8, described infra).

This technique of placing the verification code values/markers at the beginning and end points of the data is advantageous in various scenarios, such as with, e.g., buffer overflow. For example, placing verification code marks at the beginning and end of a memory buffer (e.g., a network memory buffer) enables detection of buffer overflow.

At step 710, the verification code(s) are checked to detect any stack corruption.

If there is no stack corruption detected per step 712, the function is returned per step 716. However, if stack corruption is detected per step 712, the system error handler will be called (per step 714) instead of the function returning with a bad stack (which would also likely contain a corrupted return address).

FIG. 8 is a graphical representation of one exemplary implementation of verification code 800 used to detect corruption of the thread stack frame in the function “stack checking example”, in accordance with the exemplary methodology 700 of FIG. 7, described supra.

According to this implementation, the data corruption verification code is used to detect stack corruption within the “stack checking example” function. In general, a hashed value of a “cookie” is placed at the top and the bottom of the local stack frame. If the stack is corrupted, the hash of the cookie will detect the corruption and the system error handler will be called instead of the function returning with a bad stack (which would also likely contain a corrupted return address).

### Linked-List and General Pointer Corruption-

In addition to the foregoing types of corruption, all linked-list processing is susceptible to data corruption.

Referring now to FIG. 9, one exemplary embodiment of a method 900 for providing enhanced data corruption in accordance with the present disclosure is described. In the exemplary embodiment of the method 900, the data corruption verification code can be used detect corruption of significant function pointers.

At step 902, a pointer is set to an initial thread. For example, in one variant, a created_threads pointer (e.g., “created_threads_pointer”) can be set to an initial thread (e.g., “intitial_thread_pointer), as shown in the exemplary code of FIG. 10 described infra.

At step 904, a verification code for the pointer is generated and stored. The verification code is calculated and stored when the pointer is set for the first time. In one embodiment, the algorithm of Eqn. (6) is used:

Verification Code−((Pointer Data))+(Address to Store Verification Code)+(Secret))\hat{ }(Secret) Eqn. (6)

In accordance with various other embodiments, variations of the exemplary algorithm of Eqn. (6) could be utilized.

At step 906, the pointer function verification code is set for subsequent verification. For example, in the exemplary code shown in FIG. 10 described infra, the created threads pointer verification code can be set to “build and store hash((unassigned long) created_threads_pointer, &secret, &created_threads_pointer_hash).”

At step 908, at least a portion of the program (e.g., RTOS program) can be executed.

At step 910, a determination of whether the pointer verification code is valid is made.

For example, in the exemplary code shown in FIG. 10 described infra, the verification determination can be made by the instruction “check for memory corruption((unassigned long) created_threads_pointer, &secret, &created_threads_pointer_hash).”

If the pointer verification code is determined to not be valid (per step 912), the system error handler is called per step 914.

Alternatively, if the pointer verification code is determined to be valid (per step 912), the pointer can be used or accessed per step 916. For example, in the exemplary code shown in FIG. 10 described infra, the created threads pointer can be used by “working_thread_pointer=created_threads_pointer.”

FIG. 10 is a graphical representation of one exemplary implementation for use of verification code function 1000 to detect corruption of the “created_threads pointer” before it is used, in accordance with the exemplary methodology of FIG. 9, described supra.

In this implementation, the data corruption verification code is used to validate the “created_threads_pointer.” When the created_threads pointer is set for the first time, the hash is calculated and stored. Then before any de-reference of the “created_threads_pointer” the hash is checked first before it is used. If there is an error, the system error handler is called.

### Exemplary System and Components-

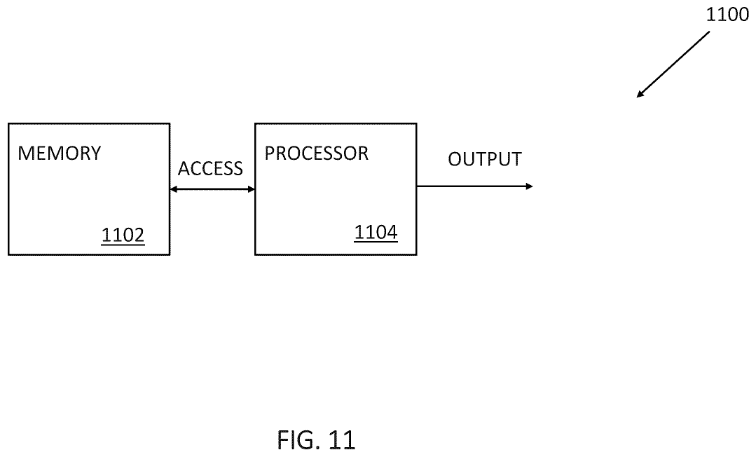

FIG. 11 illustrates one exemplary embodiment of an enhanced data corruption detection architecture 1100 according to the present disclosure. As shown in FIG. 11, the exemplary apparatus 1100 is configured to detect data corruption as early as possible to, inter alia, mitigate the damage caused by data corruption. As previously noted, finding the data corruption early also helps make isolating the source of the corruption easier.

The system 1100 includes a memory 1102 and a processor apparatus 1104 in data communication with the processor via a data interface. The memory 1102 stores one or more verification codes at one or more respective addresses. The processor apparatus 1104 is configured to, inter alia, generate verification data for one or more data values.

After the verification code (data) is generated, the processor apparatus 1104, inter alia, stores the verification data in memory 1102. Subsequently—for example, later in program (e.g., RTOS program) execution—the processor apparatus 1204 further checks if the verification code is still valid. If the verification code is still valid, the processing continues normally. Alternatively, if the verification code is not valid, the processor apparatus 1104 invokes a system error handler, and the application or a supervisory process chooses what to do next.

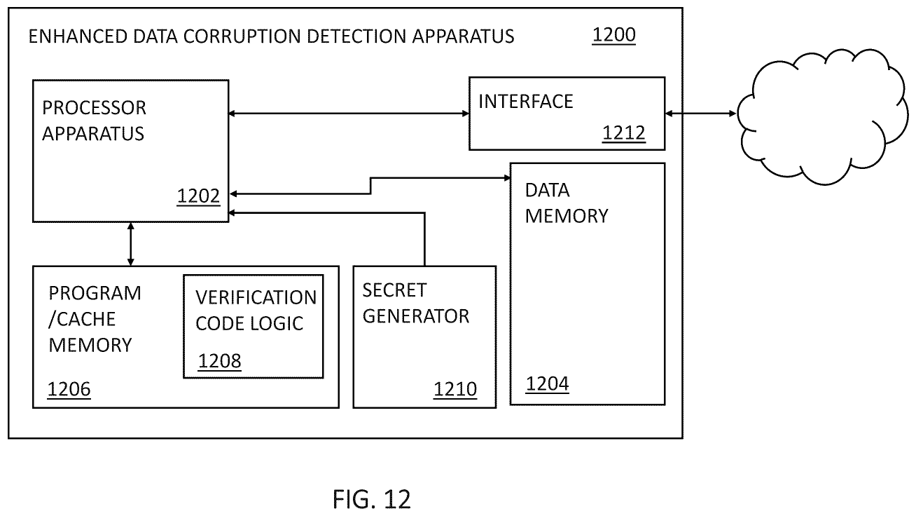

FIG. 12 illustrates one exemplary embodiment of an enhanced data corruption detection apparatus 1200 useful with the present disclosure. As shown, program memory 1206 includes a plurality of executable instructions, which includes executable instructions or logic 1208 to generate one or more verification codes (and perform subsequent operations such as verification via comparison, etc.).

The enhanced data corruption detection apparatus 1200 also includes the processor apparatus 1202, data memory 1204, a network interface 1214, and secret data generator 1210, which is configured to generate a unique code used in the algorithm to generate the verification code. In one variant, the secret generator 1210 is a hardware True Random Number Generator (TRNG), although other types of devices or functions may be used consistent with the disclosure.

As previously noted, RTOS program code and data can be combined with the application's code and data, in a monolithic image. The code portion of this image is most often located in program memory 1206 (e.g., Flash), which is naturally resistant to corruption. However, the data (contrast: code image) of both the RTOS and the application is stored in data memory 1204 (e.g., Random Access Memory or RAM), and is susceptible to corruption. The processor apparatus 1202 in FIG. 12 is in one embodiment configured to generate the hash the data relating to both the RTOS and the application (i.e., according to Eqns. (1)-(6), depending on the particular function), store the hash(es) in the data memory 1204, and subsequently verify the respective hash(es) to detect data corruption of the data stored in the data memory 1204.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. This description is in no way meant to be limiting, but rather should be taken as illustrative of the general principles of the disclosure. The scope of the disclosure should be determined with reference to the claims.

It will be further appreciated that while certain steps and aspects of the various methods and apparatus described herein may be performed by a human being, the disclosed aspects and individual methods and apparatus are generally computerized/computer-implemented. Computerized apparatus and methods are necessary to fully implement these aspects for any number of reasons including, without limitation, commercial viability, practicality, and even feasibility (i.e., certain steps/processes simply cannot be performed by a human being in any viable fashion).

What is claimed is:

1. A computerized method for providing enhanced data corruption detection of a computer program, the computerized method comprising:
generating a verification code;
storing the verification code; and
subsequent to the storing, verifying the stored verification code.

2. The computerized method of claim 1, wherein the generating and the storing of the verification code comprises:
generating a unique code;
utilizing the unique code, at least one data value, and a storage address to generate the verification code; and
storing the verification code at the verification code storage address.

3. The computerized method of claim 1, wherein the verifying of the stored verification code comprises:
subsequent to some execution of the computer program, utilizing the unique code, the at least one data value, and the storage address to generate another verification code; and
determining whether the another verification code matches the stored verification code.

4. The computerized method of claim 3, further comprising, based on the determining indicating that the another verification code matches the stored verification code, cause continuation of execution of the computer program.

5. The computerized method of claim 3, further comprising, based on the determining indicating that the another verification code does not match the stored verification code, calling a system error handler.

6. The computerized method of claim 1, wherein the computer program is at least one of (i) an operating system computer program, or (ii) an application program.

7. The computerized method of claim 6, wherein the operating system computer program comprises a real-time operating system (RTOS) program.

8. Computerized embedded apparatus, comprising:
data storage apparatus;
processor apparatus in data communication with the storage apparatus; and
storage apparatus in data communication with the processor apparatus, the storage apparatus comprising at least one computer program having a plurality of instructions, the plurality of instructions configured to, when executed by the processor apparatus, cause the computerized apparatus to:
execute an RTOS program, the execution of the RTOS program comprising execution of a low-complexity verification algorithm, the low-complexity verification algorithm (i) comprising at least one of temporal properties or spatial properties, and (ii) configured to rapidly detect data corruption within a threshold amount of time relative to commencement of the execution of the RTOS program.

9. The computerized embedded apparatus of claim 8, wherein the execution of the low-complexity verification algorithm comprises, during a first period of time relative to commencement of the execution of the RTOS program:
generation of a first unique identifier;
utilization of the first unique identifier to generate a first verification variable; and
storage of the verification variable at a storage location.

10. The computerized embedded apparatus of claim 9, wherein the generation of the first unique identifier comprises generation of the first unique identifier via use of a hardware true random number generator (TRNG).

11. The computerized embedded apparatus of claim 9, wherein:
the generation of the first unique identifier comprises assignment of the first unique identifier to a pointer; and
the execution of the low-complexity verification algorithm further comprises utilization of the pointer to determine an address of the storage location used to store the first verification variable.

12. The computerized embedded apparatus of claim 11, wherein the low-complexity verification algorithm comprises an equation comprising a sum of (i) values associated with data of the RTOS program, (ii) the address of the storage location, and (iii) the first unique identifier, which is squared by the first unique identifier.

13. The computerized embedded apparatus of claim 11, wherein the execution of the low-complexity verification algorithm further comprises, during a second period of time relative to commencement of the execution of the RTOS program, the second period of time being after the first period of time:
generation of a second unique identifier via utilization of the pointer;
utilization of the second unique identifier to generate a second verification variable; and
determination of whether the first unique identifier matches the second verification variable.

14. The computerized embedded apparatus of claim 13, wherein the plurality of instructions configured to, when executed by the processor apparatus, cause the computerized apparatus to:
execute computerized logic, the computerized logic configured to:
(i) based on the determination indicating that the first unique identifier matches the second verification variable, continue processing of the RTOS program; and
(ii) based on the determination indicating that the first unique identifier does not match the second verification variable, call a system error handler.

15. The computerized embedded apparatus of claim 13, wherein the plurality of instructions configured to, when executed by the processor apparatus, cause the computerized apparatus to:
based on the determination indicating that the first unique identifier does not match the second verification variable:
modify one or more values associated with data of the RTOS program;
generate a third unique identifier via utilization of the pointer;
utilization of the third unique identifier to generate a third verification variable; and
determination of whether the first unique identifier matches the third verification variable.

16. Computer readable apparatus comprising a non-transitory storage medium, the non-transitory storage medium comprising at least one computer program having a plurality of instructions, the plurality of instructions configured to, when executed by a processing apparatus, cause a computerized apparatus to:
utilize a low-complexity verification algorithm to generate an initial data value associated with data of an application program and detect corruption of at least one of (i) the initial data value or (ii) a storage address of the initial data value.

17. The computer readable apparatus of claim 16, wherein the low-complexity verification algorithm comprises four (4) assembly instructions, the four (4) assembly instructions comprising:
(i) a load instruction;
(ii) an add instruction configured to adds register values;
(iii) an exclusive OR (XOR) instruction subsequent to the execution of the add instruction, the XOR instruction configured to complete a computation of a value, and
(iv) a store instruction to store the computed value in a register.

18. The computer readable apparatus of claim 16, wherein the initial data value is utilized as a verification fingerprint for data relating to at least one of: (i) function pointers, (ii) function return address, (iii) stack corruption, or (iv) linked-list and general pointer corruption.

19. The computer readable apparatus of claim 16, wherein the application program is stored in random access memory (RAM) of the computerized apparatus.

20. The computer readable apparatus of claim 16, wherein the detection of the corruption of the at least one of (i) the initial data value or (ii) the storage address of the initial data value, is based on a plurality of iterations of generating other data values and comparing the other data values to the initial data value.
